(19) United States
(12) Patent Application Publication
(10) Pub. No.: US 2013/0201794 A1
(43) Pub. Date: Aug. 8, 2013

(54) SYSTEM, METHOD, AND COMPUTER-READABLE MEDIUM FOR INTERACTIVE IDENTIFICATION OF SUBSURFACE REGIONS

(71) Applicant: Headwave, Inc., Houston, TX (US)

(72) Inventors: Ronald Masters, Sugar Land, TX (US); Brian Barran, Sugar Land, TX (US)

(73) Assignee: HEADWAVE INC., Houston, TX (US)

(21) Appl. No.: 13/758,079

(22) Filed: Feb. 4, 2013

Related U.S. Application Data
(60) Provisional application No. 61/594,125, filed on Feb. 2, 2012.

(51) Int. Cl. G01V 1/34

(52) U.S. Cl. CPC G01V 1/34
USPC 367/70

(57) ABSTRACT

A computer-implemented method, apparatus, and system for interactive identification of subsurface regions that represent lithology and/or fluid anomalies that indicate the presence of hydrocarbons may be provided. Since the introduction of AvO classes, AvO interpretation has largely been quantitatively driven through polygonal selection of non-background trend values from cross plots of seismic and/or derived seismic attributes such as intercept and slope. Embodiments of the invention may provide a system and/or method which allows qualitative and quantitative, interactive, visual observation of AvO and petrophysical classes and projections simultaneously, through, for example, co-blending based an intuitive parameterization of gradational color tables with varying opaqueness along axes representing respectively background trend and anomaly, or petrophysical variables.

### RELATED APPLICATIONS

This patent application claims the benefit of U.S. Provisional Patent Application No. 61/594,125, filed Feb. 2, 2012. U.S. Provisional Patent Application No. 61/594,125 is hereby incorporated by reference in its entirety.

### BACKGROUND

### Field of Invention

Embodiments of the present invention relate generally to the identification of subsurface regions, and more particularly to a system, method, and computer-readable medium for the detection of hydrocarbons.

### SUMMARY

Aspects of the invention involve systems, methods, and computer readable medium. In one embodiment, a computer-implemented method may exist for identification of subsurface lithology or fluid types. The method may include: receiving a subsurface three-dimensional image by a computer; receiving or creating vector attributes representing amplitude versus offset (AvO) or other subsurface properties based on the subsurface three-dimensional image by the computer; interpolating colors along curvilinear coordinates among two or more axes of a cross-plot by the computer; displaying, by the computer, the interpolated colors simultaneously as a background in the cross plot and at locations in the subsurface three-dimensional image where corresponding vector attributes occur; enhancing recognition of subsurface features by changing colors in the cross plot and subsurface view by transforming the coordinate system by the computer; and changing the opacity of a portion of the cross plot background by the computer to further enhance recognition of subsurface features.

In another embodiment, a system may exist for identification of subsurface regions. The system may include: an input device for receiving seismic data; a storage device for storing the seismic data; a processor configured to: indicate a multidimensional coordinate transform using color variation based on the seismic data; and interpolate and extrapolate various colors along one or more axes or curved scales in a multidimensional space to fill a space along non-Cartesian contours by the computer, wherein the various colors identify corresponding coordinates before and after the transform.

In yet another embodiment, one or more tangible non-transitory computer-readable storage media may exist for storing computer-executable instructions executable by processing logic. The media may store one or more instructions for designing coordinate transforms and colorations to illustrate theoretical models of data distributions in a space and to classify data distributions in the space.

### BRIEF DESCRIPTION OF THE DRAWINGS

The foregoing and other features and advantages of the invention will be apparent from the following, more particular description of various exemplary embodiments, as illustrated in the accompanying drawings wherein like reference numbers generally indicate identical, functionally similar, and/or structurally similar elements. The first digits in the reference number generally indicates the drawing in which an element first appears.

FIG. 1 depicts an illustrative set of defined AvO classes or categories proposed by Rutherford and Williams;

FIG. 2 depicts an illustrative color coding of AvO responses;

FIG. 3 depicts an illustrative cross plot displaying a set of predefined AvO classes;

FIG. 4 depicts an illustrative workflow describing the collection of seismic data and visual interpretation of the seismic data;

FIG. 5 depicts an illustrative cross plot of FIG. 3 with an illustrative data distribution;

FIG. 6 depicts an illustrative seismic section with AvO classes highlighted;

FIG. 7 depicts an illustrative cross plot using rock physics models to constrain solutions;

FIG. 8 depicts an illustrative workflow describing an improved visual interpretation of the seismic data;

FIG. 9 depicts an illustrative selection of a region of interest in which two attributes are defined;

FIG. 10 depicts an illustrative cross plot and a region of interest showing the data distribution in the cross plot and the locations in the subsurface colored by their cross plot coordinates;

FIG. 11 depicts an illustrative transformation of cross plot coordinates to improve discernment of anomalous region;

FIG. 12 depicts an illustrative reduction of opacity for less anomalous data;

FIG. 13 depicts an illustrative assigning of complementary colors at extrema of ranges for coordinate axes; and

FIG. 14 depicts an illustrative computer system for use with an example method of providing interactive identification of subsurface regions.

### DESCRIPTION OF THE EMBODIMENTS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

All publications cited herein are hereby incorporated by reference in their entirety.

As used herein, the term “a” refers to one or more. The terms “including,” “for example,” “such as,” “e.g.,” “may be” and the like, are meant to include, but not be limited to, the listed examples. The term “product” may refer to both products and services.

The use of seismic data such as near offset versus far offset data or derived attributes such as intercept and slope may be used to identify amplitude versus offset (AvO) effects indicating subsurface regions of lithologies and/or fluid types, including the presence of hydrocarbons. See for example, U.S. Pat. No. 5,440,525, the contents of which are herein incorporated by reference.

Seismic data may be acquired on-shore or off-shore. Acoustic energy (e.g., a “shot”) may be used to create reflections from the subsurface which may be recorded as amplitudes. Seismic processing and imaging techniques may be applied to de-noise the data and to position the sound reflection at a specific location. The resulting dataset may be a pre-stack dataset in which, for example, the amplitude values of each X, Y position is defined on a seismic gather of {offset, time} or if those values have been averaged (e.g., “stacked”) each X, Y position has a given amplitude at a given {time}.

From the pre-stack data it may be possible to derive different attributes, such as near stacks (e.g., a summation and averaging of the values from the near offset) or far stacks (e.g., a summation and averaging of the values from far offsets), or other derived attributes such as intercept and slope. These attributes may be used in multiple combinations to assist in the exploration for and interpretation of oil and gas reservoirs, for example. The discovery of the AvO (amplitude versus offset) relation, led to development of supporting theory as well as tools to assist in the analysis of AvO anomalies.

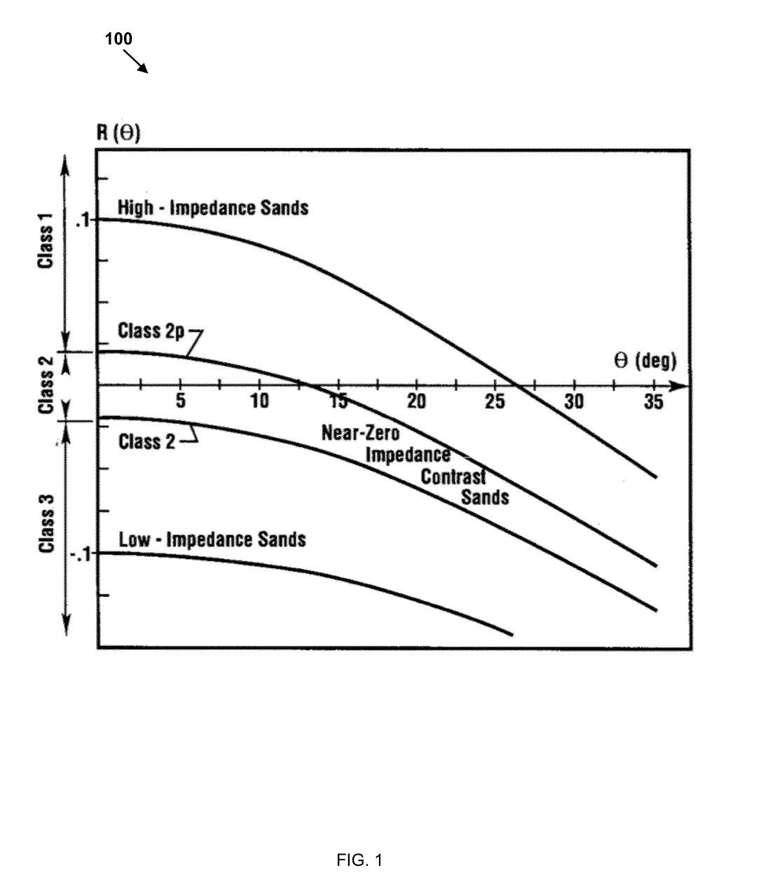

The quantitative nature of the discovery of the AvO relationship led to development of equally quantitatively driven analysis tools. FIG. 1 depicts an illustrative set of defined AvO classes or categories 100 proposed by Rutherford and Williams (1995).

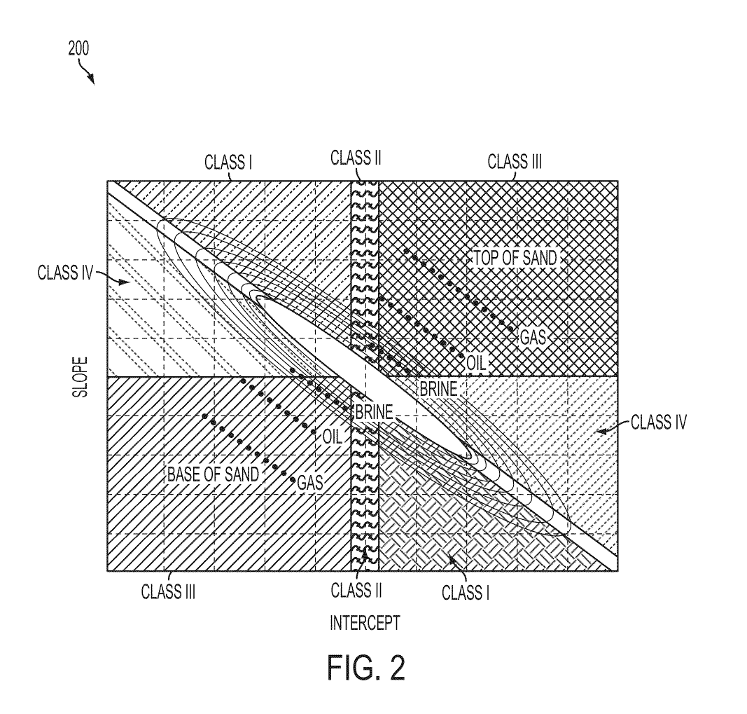

FIG. 2 depicts an illustrative color coding of AvO responses 200. Color coding of AvO responses 200 depicts a sample classification scheme for identifying the magnitude and class of a seismic reflection. The polarity convention in color coding of AvO responses 200 denotes a decrease in acoustic impedance by a peak, for example.

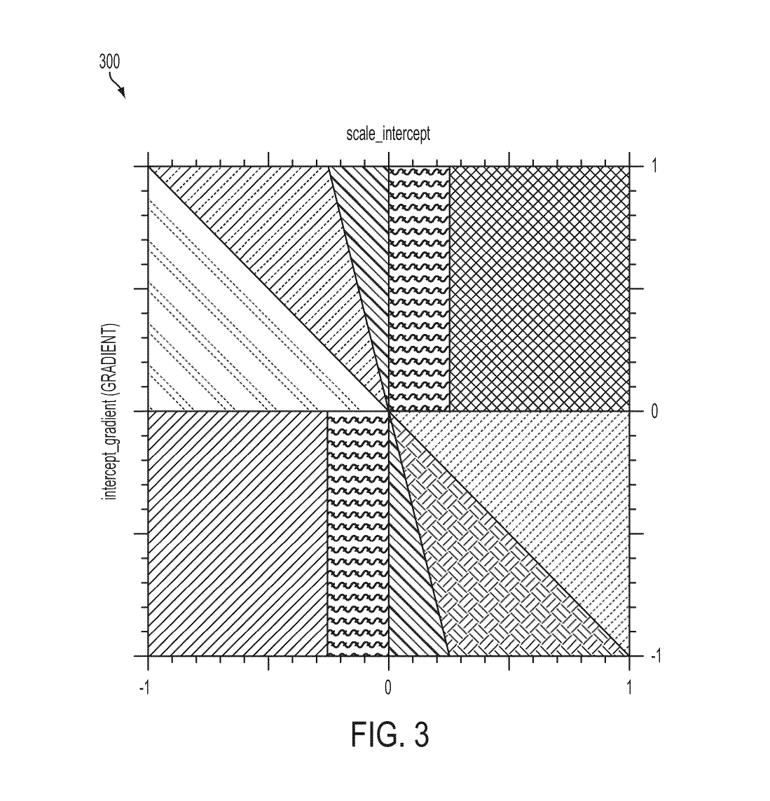

FIG. 3 depicts an illustrative cross plot 300 displaying a set of predefined AvO classes. Cross plot 300 illustrates the set of defined AvO classes or categories 100 of FIG. 1 as a cross plot. The varying colors in FIG. 3 may indicate the various class or categories (e.g., high-impedance sands, near-zero impedance contrast sands, low-impedance sands, etc.)

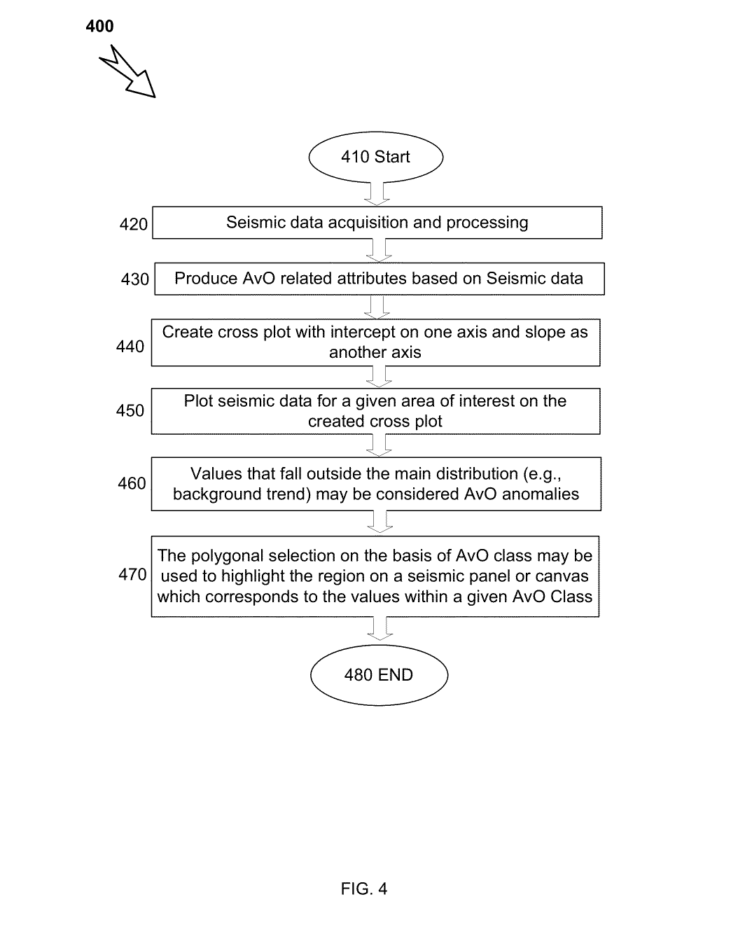

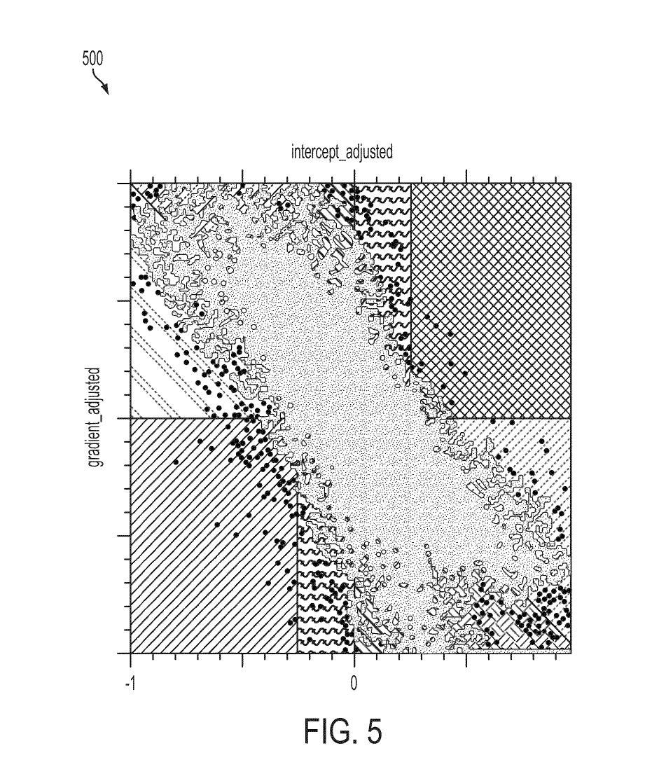

FIG. 4 depicts an illustrative workflow 400 describing the collection of seismic data and visual interpretation of the seismic data. In 410, flow begins and moves to 420. In 420, seismic data may be acquired. From 420, flow may move to 430 where the seismic data is processed to produce AvO related attributes such as near/far stacks and/or intercept/slope. From 430, flow may move to 440 where a cross plot may be created with, for example, intercept along one axis and slope as the other axis. From 440, flow may move to 450 where Seismic data may be plotted on the cross plot created in 440. From 450, flow may move to 460 where values that are determined to be outside the main distribution may be considered AvO anomalies. FIG. 5 depicts a cross plot such as that described in 460 with the AvO anomalies removed. From 460, flow may move to 470 where the polygonal selection on the basis of AvO class may be used to highlight the region on a seismic panel or canvas which corresponds to the values within a given Avo Class. From 470, flow may move to 480 and end.

FIG. 5 depicts another cross plot with an illustrative seismic data distribution such as described in 460.

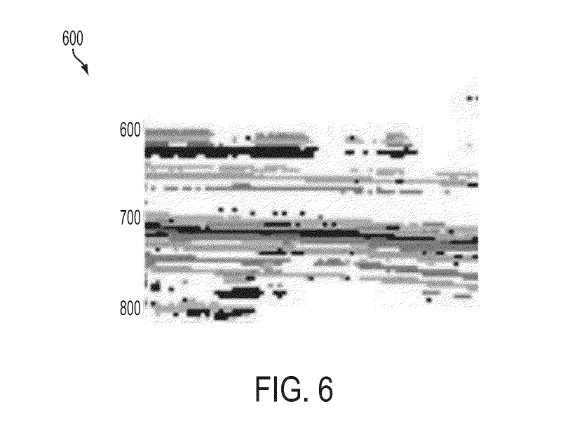

FIG. 6 depicts an illustrative seismic section with AvO classes highlighted such as described in 470. The various AvO classes or categories may be identified, highlighted, and/or distinguished (e.g., various colors) in the region or seismic panel.

Workflow 400 may improperly identify and categorize outliers as predefined AvO classes due to the inherent noise and variability in the collected seismic data. The improper categorizations may, for example, lead to erroneous assessment of the size and location of subsurface hydrocarbon reservoirs, based on apparent AvO “direct hydrocarbon indicators”.

An embodiment improves recognition of subsurface features, while avoiding predefined, highly quantitative assumptions about data distributions and corresponding AvO classes. For example, the predefined AvO quantitative class definition may be circumvented by employing, for example, a real-time visualization technique controlled by the user.

Attributes may be defined as variables representing measurable properties or functions thereof, for example, compressional-wave and/or shear-wave impedances at a location in the subsurface; seismic amplitudes on near-offset and/or far-offset traces in a common reflection point gather at a given arrival time; and/or parameters of a function representing the amplitude variation with offset. The attributes may be known in a region of the earth's subsurface from a previous calculation, or may be calculated in real time while the technique is applied. A data distribution (e.g., the number of occurrences of each set of attributes) may be plotted in Cartesian coordinates to form, for example, a “cross plot.” In addition, or alternatively, theoretical relationships among the attributes may be displayed in a cross plot; for example the range of attributes corresponding to variations of independent variables in the theory, or the trajectory followed by the attributes as one or more independent variables varies. Colors may be assigned to coordinates in the cross plot to visualize the locations in the subsurface with corresponding properties.

“Color” may refer to a set of four components, such as Red, Green, Blue, and Opacity (e.g., Alpha). In other embodiments, alternative descriptions, such as Hue, Saturation, Lightness and Opacity may be implemented. In one embodiment, colors along each axis are interpolated between the values at the extrema, and colors at the extrema are continued beyond the range. However, any color variation along any color axis may be used. For example, Opacity variation along each axis will be defined independently, and often according to different design criteria.

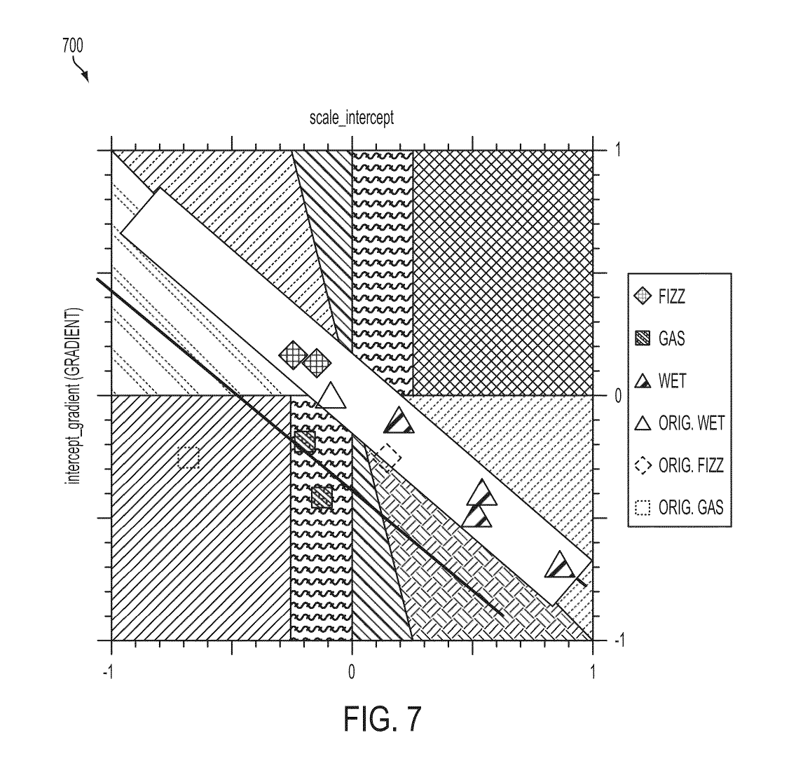

FIG. 7 depicts an illustrative cross plot using rock physics models to constrain solutions.

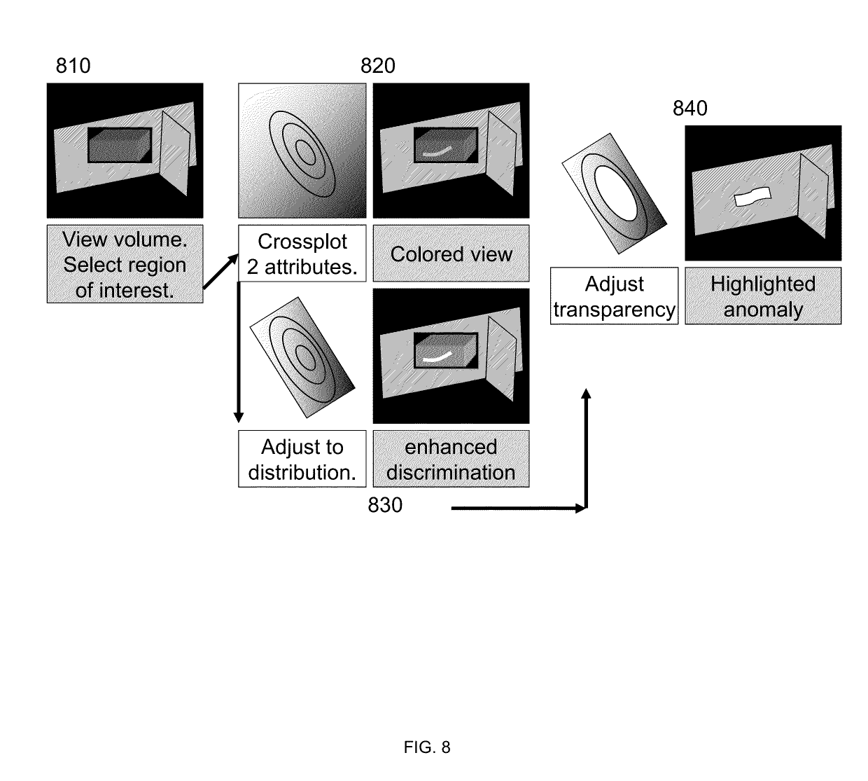

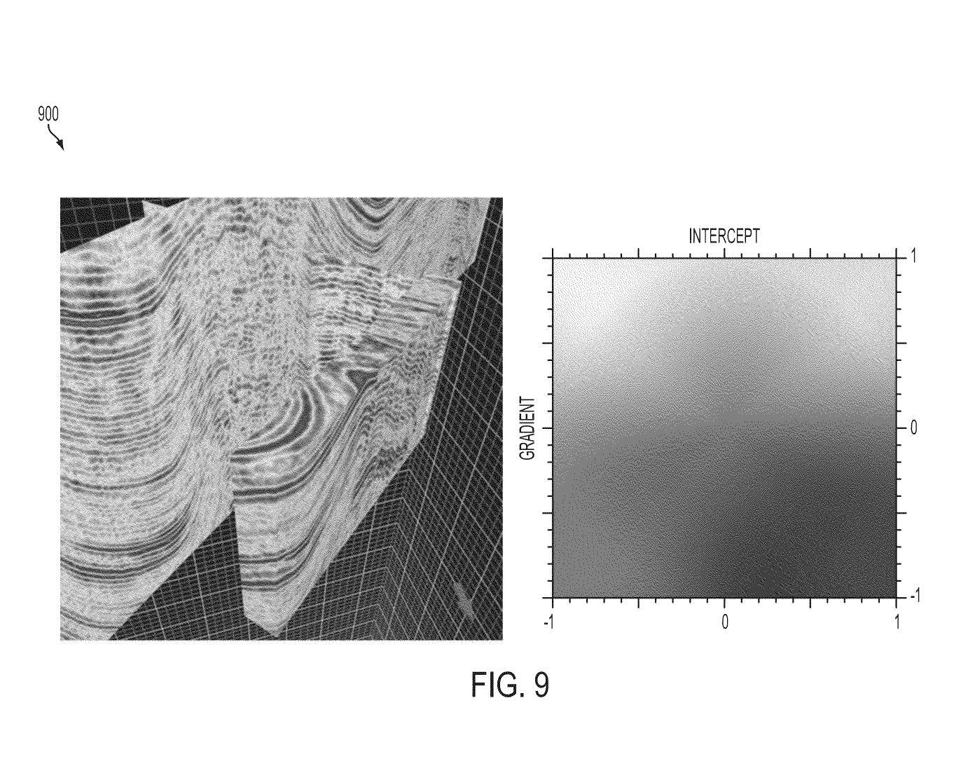

FIG. 8 depicts an illustrative workflow describing an improved visual interpretation of the seismic data and outlines an embodiment of a real-time visualization technique. In 810, a user may observe a three-dimensional view of the subsurface, and may select a subset where attribute vectors are known, as a source for a data distribution. In 820, a user may inspect a cross plot in which colors are interpolated along curvilinear coordinates among two or more axes, and a modified subsurface view. In FIG. 9, for example, the distribution of attributes in the selected subset may be represented by contours in the cross plot. Other representations of the distribution are possible, and a user might choose not to display the distribution. Theoretical relationships could be displayed in the cross plot instead of, or along with, one or more representations of the distribution. The modified subsurface view shows the colors that underlie each coordinate in the cross plot at subsurface locations where that attribute vector occurs. The portion of the subsurface view colored in this way may be the selected source of the distribution, or any region chosen by the user, or multiple regions. In 830, a user may transform the coordinate system, and may observe the changing colors in the cross plot and subsurface view. In 840, a user may change the opacity of a portion of the cross plot background and may observe the changes in both displays. Other color components may also be varied, individually or in groups, in various regions of the cross plot. After an initial selection of a source for the data distribution, all four steps may be performed and changed repeatedly in any order. Throughout the process, a user may observe features in each display, and form judgments about their nature based on both displays.

FIG. 9 depicts an illustrative selection of a region of interest in which two attributes are defined.

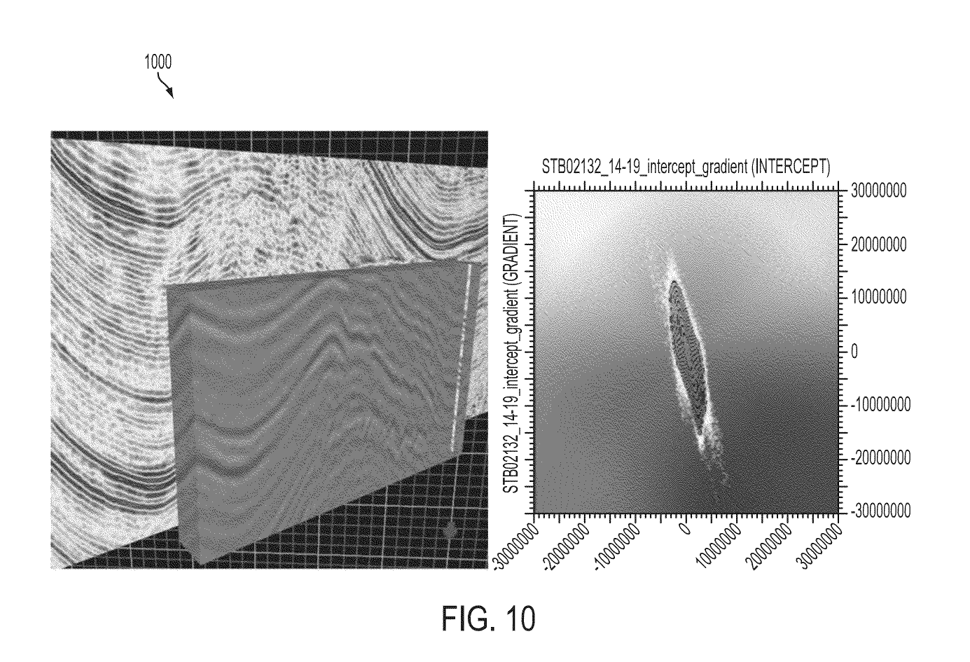

FIG. 10 depicts an illustrative cross plot and a region of interest showing the data distribution in the cross plot and the locations in the subsurface colored by their cross plot coordinates.

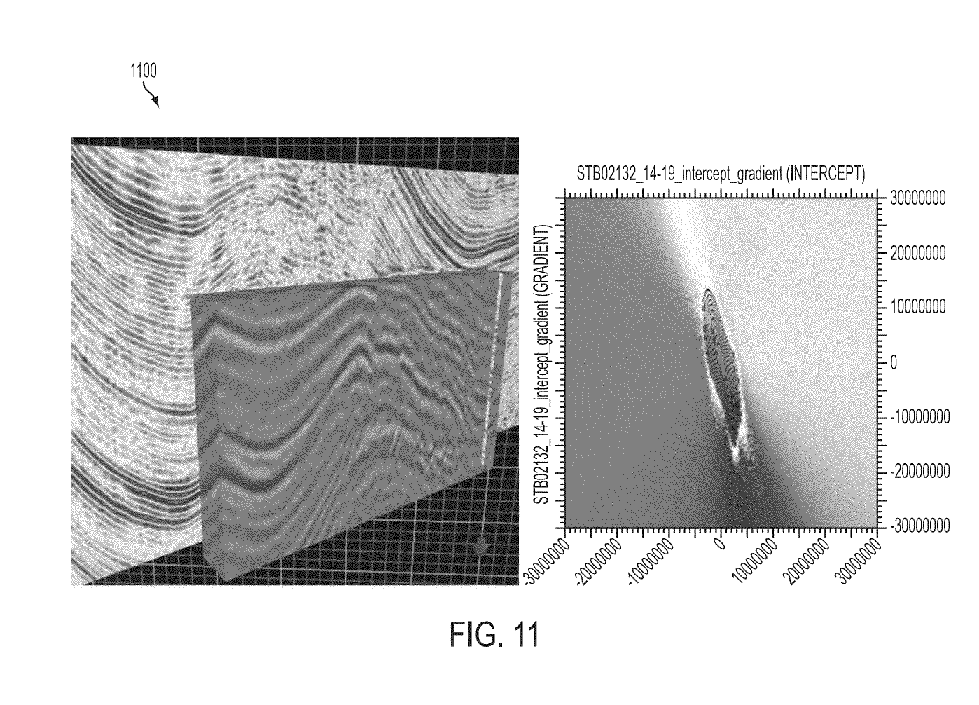

FIG. 11 depicts an illustrative transformation of cross plot coordinates to improve discernment of anomalous region.

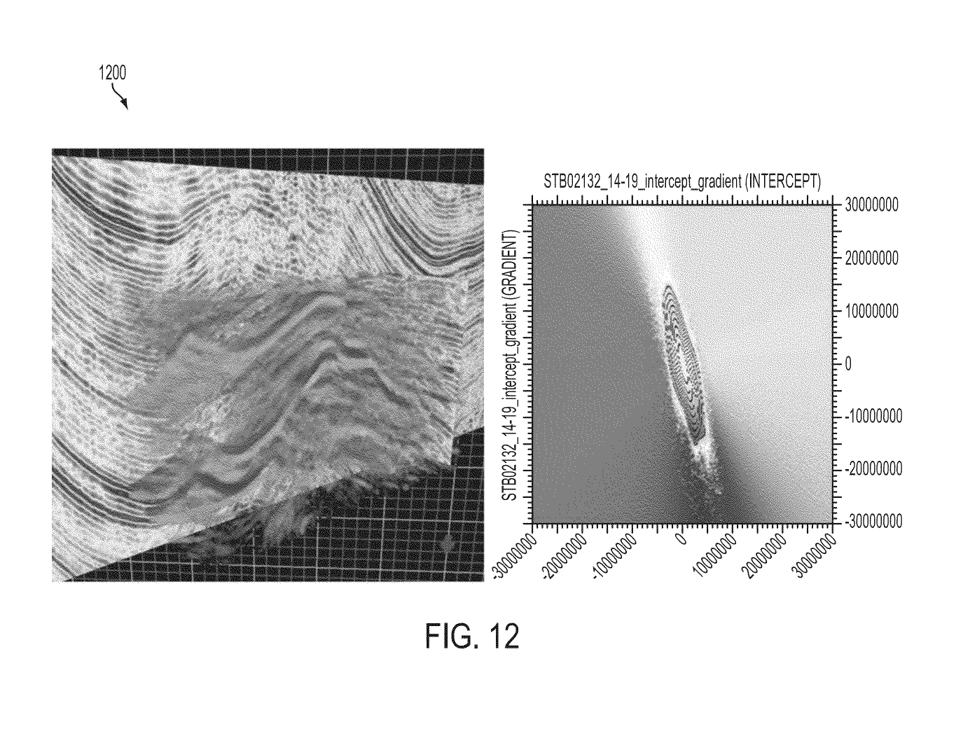

FIG. 12 depicts an illustrative reduction of opacity for less anomalous data.

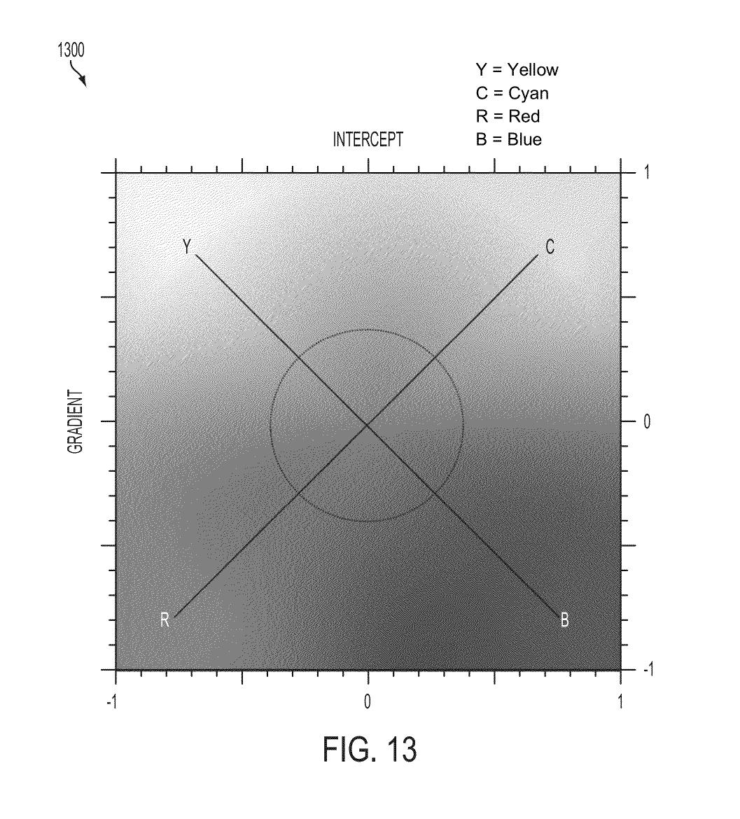

FIG. 13 depicts an illustrative assigning of complementary colors at extrema of ranges for coordinate axes. In FIG. 13, colors are interpolated along axes, and along curvilinear trajectories (here, circles) between axes. In FIG. 13, colors may include yellow (Y), cyan (C), red (R), and blue (B). However, any color variation along any color axis may be used. Embodiments may vary depending on the design criteria. For example, opacity variation along each axis may be defined independently according to different design criteria.

The axes may be linear or curved. Elsewhere in the space, colors may be interpolated among the axes, along contours appropriate for a theoretical model or a data distribution. There may be more axes than dimensions. In one embodiment, the interpolation follows radial coordinates relative to the axes. In another embodiment the interpolation follows theoretical functions of the variables. In various embodiments, each color may identify a location in one coordinate system. Various alternative colorations may be adopted.

After coordinate transformation, color may identify corresponding locations in the original and transformed coordinates. In one embodiment, a transform designer, for example, may interactively rotate and scale the axes. In other embodiments the axes may be translated and/or the angles between the axes may be varied. In some embodiments, coordinate transformations may be designed automatically to fit data distributions or theoretical models.

A designer may begin with a cross plot which has a Yellow-to-Blue axis intended to represent the dominant correlation among two attributes, and a Red-to-Cyan axis intended to represent anomalies in the data distribution. The axes may be interactively or automatically rotated and scaled to approximate the attribute distribution in a region of the subsurface, guided by an overlay representing the distribution. Interpolation may be along radial coordinates in the untransformed coordinate system. This method would be appropriate for, inter alia, seismic Amplitude v. Offset analysis. Regions of constant Hue in the cross plot may correspond to AvO classes, and regions with higher Saturation may indicate higher seismic reflectivity. The regions with higher Saturation characteristics may be associated with fluid content and lithology. Opacity values may be varied along each axis to hide regions of low reflectivity, regions along the correlation trend, and/or regions in which the sign of the reflectivity may not be indicative of hydrocarbon prospects. Similarly, a designer may analyze seismic elastic impedance volumes with coloration following theoretical functions designed according to Rock Physics Templates (as shown, for example, in FIG. 7). The coordinates could be scaled to calibrate the measured and theoretical values, either automatically or interactively.

In these and other cases, designers may choose a variety of coordinate colorations and transformations that help draw attention to the attribute ranges of interest, depending on cultural conventions and local earth environments. For example, in the Oil & Gas industry, specific colors are associated with oil and with gas on maps of prospective or producing areas. The measured values associated with hydrocarbon reservoirs and resources vary with subsurface pressure, temperature, fluid and sediment type, sediment age, and other factors related to the earth and the measurement systems.

In one embodiment, a computer-implemented method may indicate a multidimensional coordinate transform by color variation. Colors may vary along one or more axes or curved scales in a multi-dimensional space and may be interpolated and extrapolated to fill the space, along non-Cartesian contours. Color may identify corresponding coordinates before and after the transform. The transform and the coloration may be guided by data distributions and/or theoretical models in the multidimensional space. Coordinate transforms and colorations may be designed to illustrate theoretical models of data distributions in the space and/or to classify data distributions in the space.

In another embodiment, a computer program may design multidimensional coordinate transforms and colorations which may adapt to data and/or theoretical models. The computer program may be interactive and a designer, for example, may adapt the multidimensional coordinate transforms and colorations in response to data and/or theoretical models.

In yet another embodiment, a system and/or method for interactive identification of subsurface extent of lithologies and/or fluid types, including hydrocarbons. Since the introduction of Amplitude v. Offset (AvO) classes, interpretation of AvO—and later, petrophysical parameters from pre-stack inversion—has largely been quantitatively driven through polygonal selection of non-background trend values from cross plots of seismic and/or derived seismic attributes such as intercept and slope. Embodiments of the invention may provide a system and/or method which allows qualitative and quantitative, interactive, visual observation of all AvO and petrophysical classes and projections simultaneously through, for example, co-blending gradational color tables with varying opaqueness along appropriate contours among axes representing variables of interest (e.g., background trend and anomaly, petrophysical, etc.); and transforming the coordinates to enhance recognition of subsurface features.

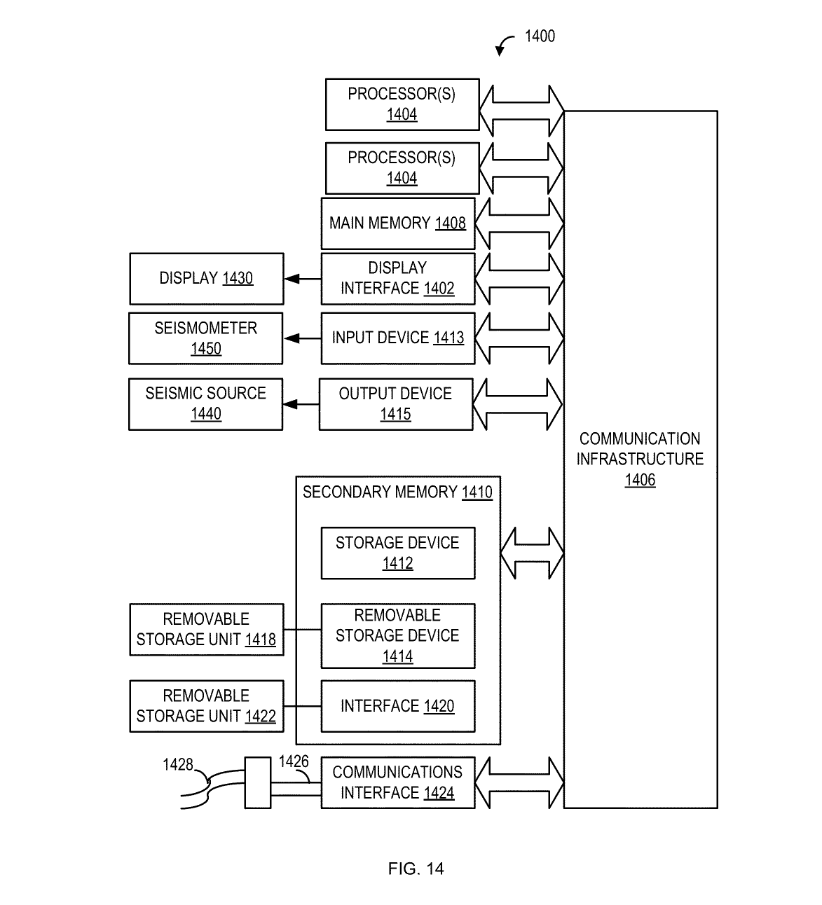

FIG. 14 depicts an illustrative computer system that may be used in implementing an illustrative embodiment of the embodiments described herein. Specifically, FIG. 14 depicts an illustrative embodiment of a computer system 1400 that may be used in computing devices such as, e.g., but not limited to, standalone or client or server devices. FIG. 14 depicts an illustrative embodiment of a computer system that may be used as client device, or a server device, etc. The present invention (or any part(s) or function(s) thereof) may be implemented using hardware, software, firmware, or a combination thereof and may be implemented in one or more computer systems or other processing systems. In fact, in one illustrative embodiment, the invention may be directed toward one or more computer systems capable of carrying out the functionality described herein. An example of a computer system 1400 is shown in FIG. 14, depicting an illustrative embodiment of a block diagram of an illustrative computer system useful for implementing the present invention. Specifically, FIG. 14 illustrates an example computer 1400, which in an illustrative embodiment may be, e.g., (but not limited to) a personal computer (PC) system running an operating system such as, e.g., (but not limited to) MICROSOFT® WINDOWS® NT/98/2000/XP/Vista/Windows 7/etc. available from MICROSOFT® Corporation of Redmond, Wash., U.S.A. or an Apple computer executing MAC® OS from Apple® of Cupertine, Calif., U.S.A. However, the invention is not limited to these platforms. Instead, the invention may be implemented on any appropriate computer system running any appropriate operating system. In one illustrative embodiment, the present invention may be implemented on a computer system operating as discussed herein. An illustrative computer system, computer 1400 is shown in FIG. 14. Other components of the invention, such as, e.g., (but not limited to) a computing device, a communications device, a telephone, a personal digital assistant (PDA), an iPhone, an iPad, a 3/4G wireless device, a wireless device, a personal computer (PC), a handheld PC, a laptop computer, a smart phone, a mobile device, a netbook, a handheld device, a portable device, an interactive television device (iTV), a digital video recorder (DVR), client workstations, thin clients, thick clients, fat clients, proxy servers, network communication servers, remote access devices, client computers, server computers, peer-to-peer devices, routers, web servers, data, media, audio, video, telephony or streaming technology servers, etc., may also be implemented using a computer such as that shown in FIG. 14. Computer system 1400 may be connected to a network and/or interact with a networked cloud of computers.

The computer system 1400 may include one or more processors, such as, e.g., but not limited to, processor(s) 1404. The processor(s) 1404 may be connected to a communication infrastructure 1406 (e.g., but not limited to, a communications bus, cross-over bar, interconnect, or network, etc.). Processor 1404 may include any type of processor, microprocessor and/or processing logic that may interpret and execute instructions (e.g., for example, a field programmable gate array (FPGA)). Processor 1404 may comprise a single device (e.g., for example, a single core) and/or a group of devices (e.g., multi-core). The processor 1404 may include logic configured to execute computer-executable instructions configured to implement one or more embodiments. The instructions may reside in main memory 1408 or secondary memory 1410. Processors 1404 may also include multiple independent cores, such as a dual-core processor or a multi-core processor. Processors 1404 may also include one or more graphics processing units (GPU) which may be in the form of a dedicated graphics card, an integrated graphics solution, and/or a hybrid graphics solution. Various illustrative software embodiments may be described in terms of this illustrative computer system. After reading this description, it will become apparent to a person skilled in the relevant art(s) how to implement the invention using other computer systems and/or architectures.

Computer system 1400 may include a display interface 1402 that may forward, e.g., but not limited to, graphics, text, and other data, etc., from the communication infrastructure 1406 (or from a frame buffer, etc., not shown) for display on the display unit 1430. The display until 1430 may be, for example, a television, a computer monitor, or a mobile phone screen. The output may also be provided as sound through a speaker.

The computer system 1400 may also include, e.g., but is not limited to, a main memory 1408, random access memory (RAM), and a secondary memory 1410, etc. Main memory 1408, random access memory (RAM), and a secondary memory 1410, etc., may be a computer-readable medium that may be configured to store instructions configured to implement one or more embodiments and may comprise a random-access memory (RAM) that may include RAM devices, such as Dynamic RAM (DRAM) devices, flash memory devices, Static RAM (SRAM) devices, etc.

The secondary memory 1410 may include, for example, (but is not limited to) a hard disk drive 1412 and/or a removable storage drive 1414, representing a floppy diskette drive, a magnetic tape drive, an optical disk drive, a compact disk drive CD-ROM, flash memory, etc. The removable storage drive 1414 may, e.g., but is not limited to, read from and/or write to a removable storage unit 1418 in a well-known manner. Removable storage unit 1418, also called a program storage device or a computer program product, may represent, e.g., but is not limited to, a floppy disk, magnetic tape, optical disk, compact disk, etc. which may be read from and written to removable storage drive 1414. As will be appreciated, the removable storage unit 1418 may include a computer usable storage medium having stored therein computer software and/or data.

In alternative illustrative embodiments, secondary memory 1410 may include other similar devices for allowing computer programs or other instructions to be loaded into computer system 1400. Such devices may include, for example, a removable storage unit 1422 and an interface 1420. Examples of such may include a program cartridge and cartridge interface (such as, e.g., but not limited to, those found in video game devices), a removable memory chip (such as, e.g., but not limited to, an erasable programmable read only memory (EPROM), or programmable read only memory (PROM) and associated socket, and other removable storage units 1422 and interfaces 1420, which may allow software and data to be transferred from the removable storage unit 1422 to computer system 1400.

Computer 1400 may also include an input device 1413 may include any mechanism or combination of mechanisms that may permit information to be input into computer system 1400 from, e.g., a user. Input device 1413 may include logic configured to receive information for computer system 1400 from, e.g. a user. Examples of input device 1413 may include, e.g., but not limited to, a mouse, pen-based pointing device, or other pointing device such as a digitizer, a touch sensitive display device, and/or a keyboard or other data entry device (none of which are labeled). Other input devices 1413 may include, e.g., but not limited to, a biometric input device, a video source, an audio source, a microphone, a web cam, a video camera, and/or other camera. Input device 1413 may communicate with processor 1404 either wired or wirelessly.

Input device 1413 may also include seismometer 1450 which may detect seismic energy produced by seismic source 1440 or other seismic energy. Input device 1413 may also include a flash drive, network access device, or any device capable of receiving data.

Computer 1400 may also include output devices 1415 which may include any mechanism or combination of mechanisms that may output information from computer system 1400. Output device 1415 may include logic configured to output information from computer system 1400. Embodiments of output device 1415 may include, e.g., but not limited to, display 1430, and display interface 1402, including displays, printers, speakers, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), etc. Computer 1400 may include input/output (I/O) devices such as, e.g., (but not limited to) communications interface 1424, cable 1428 and communications path 1426, etc. These devices may include, e.g., but are not limited to, a network interface card, and/or modems. Output device 1415 may communicate with processor 1404 either wired or wirelessly.

Output device 1415 may also include seismic source 1440 which may generate a controlled seismic energy which may be detected by seismometer 1450. Seismic source 1440 may include an air gun, a thumper, a plasma sound source, an electromagnetic pulse energy source, a seismic vibrator, a boomer, or other noise source.

Communications interface 1424 may allow software and data to be transferred between computer system 1400 and external devices.

In this document, the terms “computer program medium” and “computer readable medium” may be used to generally refer to media such as, e.g., but not limited to, removable storage drive 1414, a hard disk installed in hard disk drive 1412, flash memories, removable discs, non-removable discs, etc. In addition, it should be noted that various electromagnetic radiation, such as wireless communication, electrical communication carried over an electrically conductive wire (e.g., but not limited to twisted pair, CATS, etc.) or an optical medium (e.g., but not limited to, optical fiber) and the like may be encoded to carry computer-executable instructions and/or computer data that embodiments of the invention on e.g., a communication network. These computer program products may provide software to computer system 1400. It should be noted that a computer-readable medium that comprises computer-executable instructions for execution in a processor may be configured to store various embodiments of the present invention. References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic.

Further, repeated use of the phrase “in one embodiment,” or “in an illustrative embodiment,” do not necessarily refer to the same embodiment, although they may.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments may be embodied in many different ways as a software component. For example, it may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application.

According to another embodiment, embodiments may be represented by any of a number of well-known network architecture designs including, but not limited to, peer-to-peer, client-server, hybrid-client (e.g., thin-client), or standalone.

While various embodiments of the present invention have been described above, it should be understood that they have been presented by way of example only, and not limitation.

What is claimed is:

1. A system for identification of subsurface regions comprising:
an input device for receiving seismic data;
a storage device for storing the seismic data;
a processor configured to:
indicate a multidimensional coordinate transform using color variation; and
interpolate and extrapolate at least one color along at least one axes or curved scales in a multidimensional space to fill a space along non-Cartesian contours, wherein each color identifies corresponding coordinates before and after the transform.

2. The system of claim 1, wherein the transform and the coloration are guided by data distributions or theoretical models in the multidimensional space.

3. One or more tangible non-transitory computer-readable storage media for storing computer-executable instructions executable by processing logic, the media storing one or more instructions for:
designing coordinate transforms and colorations to illustrate theoretical models of data distributions in a space and to classify data distributions in the space.

4. The one or more tangible non-transitory computer-readable storage media of claim 3, wherein the designing coordinate transforms and colorations further comprise:
receiving a subsurface three-dimensional image;
receiving or creating one or more vector attributes representing amplitude versus offset (AvO) or subsurface properties based on the subsurface three-dimensional image;
interpolating one or more colors along curvilinear coordinates among two or more axes of a cross-plot;
displaying the interpolated one or more colors simultaneously as a background in the cross plot and at one or more locations in the subsurface three-dimensional image where corresponding vector attributes occur;
enhancing recognition of one or more subsurface features by changing one or more colors in the cross plot and subsurface view by transforming the coordinate system; and
changing the opacity of a portion of the cross plot background to further enhance recognition of the one or more subsurface features.

5. The one or more tangible non-transitory computer-readable storage media of claim 4, further comprising:
representing a distribution of attributes or theoretical relations among the attributes by contours in the cross plot.

6. A computer-implemented method for identification of subsurface lithology or fluid types, comprising:
receiving a subsurface three-dimensional image by a computer;
receiving or creating one or more vector attributes representing amplitude versus offset (AvO) or subsurface properties based on the subsurface three-dimensional image by the computer;
interpolating one or more colors along curvilinear coordinates among two or more axes of a cross-plot by the computer;
displaying, by the computer, the interpolated one or more colors simultaneously as a background in the cross plot and at one or more locations in the subsurface three-dimensional image where corresponding vector attributes occur;
enhancing recognition of one or more subsurface features by changing one or more colors in the cross plot and subsurface view by transforming the coordinate system by the computer; and
changing the opacity of a portion of the cross plot background by the computer to further enhance recognition of the one or more subsurface features.

7. The computer-implemented method of claim 6, further comprising:
representing a distribution of attributes or theoretical relations among the attributes by contours in the cross plot.

8. The computer-implemented method of claim 6, further comprising:
indicating areas of hydrocarbons based on the locations in the subsurface three-dimensional image where corresponding vector attributes occur.
